(19) United States
(12) Patent Application Publication
(10) Pub. No.: US 2023/0161858 A1
(43) Pub. Date: May 25, 2023

(54) METHOD AND APPARATUS FOR LOGGING INTO SYSTEM USING SMART KEY DEVICE

(71) Applicant: FEITIAN TECHNOLOGIES CO., LTD., Beijing (CN)

(72) Inventors: Zhou Lu, Beijing (CN); Huazhang Yu, Beijing (CN)

(21) Appl. No.: 17/834,689

(22) PCT Filed: Mar. 24, 2021
(86) PCT No.: PCT/CN2021/082644

§ 371 Date: Jun. 7, 2022

(30) Foreign Application Priority Data
Jul. 14, 2020 (CN) 202010671810.5

(51) Int. Cl. G06F 21/34; G06F 21/32; G06F 21/33; H04L 9/32

(52) U.S. Cl. CPC G06F 21/34; G06F 21/32; G06F 21/33; H04L 9/3226

(57) ABSTRACT

A method for logging into a system using a smart key device. The method comprises: an apparatus acquiring a login verification manner and returning same to an operating system; if the login verification manner acquired by the apparatus from a fourth function parameter is a biological feature verification manner, acquiring a login interface window handle from a fifth function parameter, and saving same; the apparatus popping up a verification prompt box according to the saved login interface window handle, to prompt a user to input a PIN code and a fingerprint so as to perform verification; and if the verification is successful, the apparatus returning verification success information to the operating system. By using the present invention, double verification with a PIN code and a biological feature can be performed on a user identity during verification and login each time, thereby improving the security of a user using a smart key device to log into an operating system, and ensuring the benefits of the user.

### FIELD OF THE INVENTION

The present invention relates to a method for logging in a system by a smart key and a device therefor, which belongs to a field of information security.

### PRIOR ART

In prior art, a verification and login of a user's identity is finished via interaction between an operating system and a smart key, there are two modes of verification at the moment, one of them is that a PIN code input by a user is verified via a smart key, the other is that the biological feature input by a user is verified via a smart key; but, the operating system only supports one of the two methods during the verification, that is not safe; thus, a safer way to log in an operating system is needed.

### SUMMARY OF THE INVENTION

The object of the present invention is to provide a method for logging in a system by a smart key and device therefor, which makes a login by the smart key safer.

Thus, according to one respect of the present invention, there is provided a method for logging in the system by the smart key, comprising:

in the case that a fourth function of the device is invoked, the device sending an instruction for obtaining login verified mode to the smart key, receiving verified mode information returned from the smart key, and the device organizes the verified mode information into a fifth data, and returning the fifth data to the operating system;

in the case that a fifth function of the device is invoked by the operating system, the device obtaining a login interface window handle from the fifth function, storing the login interface window handle into a second data structure, and returning an invoking response value to the operating system;

in the case that a sixth function of the device is invoked by the operating system, popping a verification box according to the login interface window handle in the second data structure, prompting a user to input PIN code, and sending an instruction for verifying PIN code to the smart key when the PIN code input by the user is received;

in the case that the device receives a PIN code verified result data which is returned from the smart key, the device determining whether the PIN code is verified successfully, if yes, prompting the user input biological feature information in the smart key for verification, and sending an instruction for verifying biological feature to the smart key; otherwise, prompting that the PIN code is verified unsuccessfully;

in the case that the device receives the biological feature verified result data returned from the smart key, determining, by the device, whether the biological feature is verified successfully, if yes, returning verification successful information to the operating system; otherwise, prompting the biological feature is verified unsuccessfully;

in the case that a seventh function of the device is invoked by the operating system, the device sending the data being signed to the smart key, receiving signed data returned from the smart key, the device organizing the signed data into credential information and returning the credential information to the operating system; and

in the case that an eighth function of the device is invoked by the operating system, the device sending encrypted data to the smart key, receiving decrypted data returned from the smart key, and the device organizing the decrypted data into verified data and returning the verified data to the operating system.

According to the other aspect of the present invention, there is provided a device for logging in a system by a smart key, comprising:

a fourth operation module, a fifth operation module, a sixth operation module, a seventh operation module, an eighth operation module;

the fourth operation module is configured to send an instruction for obtaining login verified mode to the smart key, to receive verified mode information returned from the smart key, and to organize the verified mode information into fifth data structure, and to return the fifth data to the operating system;

the fifth operation module is configured to obtain login interface window handle from fifth function, and to store the login interface window handle into a second data structure, and return an invoking response value to the operating system;

the sixth operation module is configured to pop a verification box according to the login interface window handle in the second data structure stored by the fifth operation module, and to prompt the user to input PIN code, and to receive the PIN code input by the user, and to send verifying PIN code instruction to the smart key;

the sixth operation module is configured to receive PIN code verified result data which is returned from the smart key, and to determine whether the PIN code is verified successfully, if yes, to prompt the user to input biological feature in the smart key for verification, and to send instruction for verifying biological feature to the smart key; otherwise, to prompt the PIN code is verified unsuccessfully;

the sixth operation module is further configured to receive the biological feature verified result data returned from the smart key, and to determine whether the biological feature is verified successfully, if yes, to return verified successfully information to the operating system; otherwise, to prompt the biological feature verified unsuccessfully;

the seventh operation module is configured to send the data being signed to the smart key, and to receive the signed data returned from the smart key, and to organize the signed data into credential information, and to return the credential information to the operating system; and

the eighth operation module is configured to send the encrypted data to the smart key, and to receive decrypted data returned from the smart key, and to organize the decrypted data into verified data and to return the verified data to the operating system.

According to the present invention, it obtains verification mode supported by the smart key via the device, returns verification type to the operating system according to verification mode, in this way, the operating system organizes the login interface window handle according to the verification type, and the device receives the login interface window handle sent from the operating system, pops up a verification box according to the login interface window handle, prompts user to verify the PIN code and the biological information. Thus, in the present invention, when login, the user identify is verified via the PIN code and the biological feature to make the login safer.

### BRIEF DESCRIPTION OF THE DRAWINGS

FIG. 1 is a flow diagram of a method for logging in a system by a smart key according to Embodiment 1 of the present invention;

FIG. 2-1 and FIG. 2-2 are a flow diagram of a method for logging in a system by a smart key according to Embodiment 2 of the present invention; and

FIG. 3 is a block diagram of device for logging in a system by a smart key.

### EMBODIMENTS FOR CARRYING OUT THE INVENTION

The technical solution in the Embodiments of the present invention is further described more clearly and completely together with the drawings of the present invention. Apparently, Embodiments described herein are just a few Embodiments of the present invention. On the basis of Embodiments of the invention, all other related Embodiments made by those skilled in the art without any inventive work belong to the scope of the invention.

### Embodiment 1

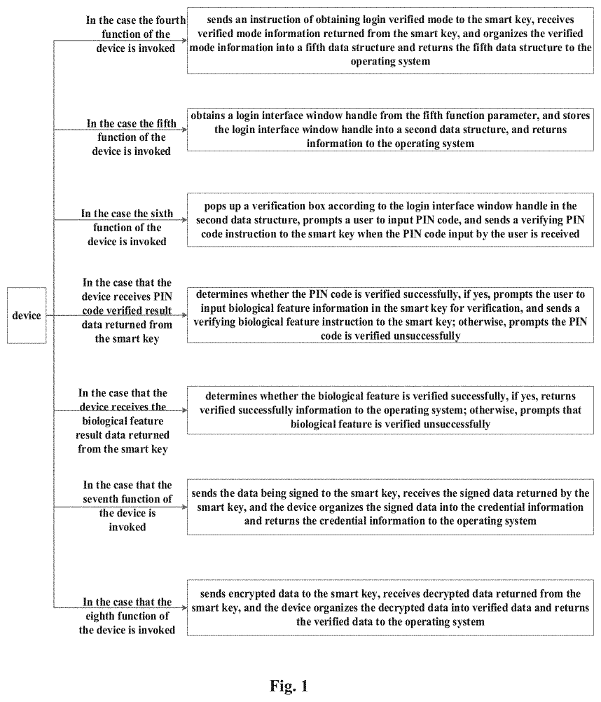

According to Embodiment 1 of the present invention, it provides a method for logging in a system by a smart key, which applies to a system which includes a device, an operating system, and a smart key, as shown in FIG. 1, comprising:

in the case that a fourth function is invoked by the operating system, the device sends an instruction for obtaining login verified mode to the smart key, receives verified mode information returned from the smart key, and organizes the verified mode information into a fifth data structure and returns the fifth data structure to the operating system;

in the case that a fifth function of the device is invoked by the operating system, the device obtains a login interface window handle from the fifth function parameter, and stores the login interface window handle into a second data structure, and returns information to the operating system;

in the case that a sixth function of the device is invoked by the operating system, the device pops up a verification box according to the login interface window handle in the second data structure, prompts a user to input PIN code, and sends a verifying PIN code instruction to the smart key when the PIN code input by the user is received;

in the case that the device receives PIN code verified result data which is returned from the smart key, the device determines whether the PIN code is verified successfully, if yes, prompts the user to input biological feature information in the smart key for verification, and sends a verifying biological feature instruction to the smart key; otherwise, prompts the PIN code is verified unsuccessfully;

in the case that the device receives biological feature verified result data returned from the smart key, determines whether the biological feature is verified successfully, if yes, returns verified successfully information to the operating system; otherwise, prompts that biological feature is verified unsuccessfully;

in the case that a seventh function of the device is invoked, the device sends the data being signed to the smart key, receives the signed data returned by the smart key, and the device organizes the signed data into the credential information and returns the credential information to the operating system;

in the case that an eighth function of the device is invoked, the device sends encrypted data to the smart key, receives decrypted data returned from the smart key, and the device organizes the decrypted data into verified data and returns the verified data to the operating system.

Preferably, in Embodiment 1, the device organizing the verified mode information into the fifth data structure, and returning the fifth data structure to the operating system specifically is that the device obtains verifying policy identification from the verified mode information returned from the smart key, and determines whether the verified mode is biological feature verified mode according to the verifying policy identification, if yes, sets the verified mode as a first preset value; otherwise, sets the verified mode as a second preset value, organizes the fifth data structure according to verified mode, and returns the fifth data structure to the operating system;

Preferably, in Embodiment 1, the method further includes that the device sends an instruction for obtaining public key information of appointed index container to the smart key according to input parameter, and receives the public key information returned from the smart key, and organizes the public key information as the fourth data structure and returns the fourth data structure to the operating system in the case that a third function of the device is invoked by the operating system;

Preferably, in Embodiment 1, the method further includes that the device obtains an input parameter file name, sends an instruction for obtaining file information to the smart key according to the file name, and receives the file information returned from the smart key, and organizes the third data structure according to the file information and returns the third data structure to the operating system in the case that a second function of the device is invoked;

Preferably, in Embodiment 1, the device obtaining the input parameter file name, sending the instruction for obtaining file information to the smart key according to the file name, and receiving the file information returned from the smart key, and organizing the third data structure according to the file information and returning the third data structure to the operating system specifically includes that

the device obtains the input parameter file name and determines the file name, the device sends an instruction for obtaining smart key serial number to the smart key according to a first file name, and receives first file information returned from the smart key, and obtains the serial number from the first file information, and organizes the third data structure according to the serial number and returns the third data structure to the operating system in the case that the file name is the first file name.

Preferably, in Embodiment 1, the device obtaining the input parameter file name, and sending the instruction for obtaining file information to the smart key according to the file name, receiving the file information returned from the smart key, and organizing the third structure data according to the file information and returning the third structure data to the operating system specifically includes that

the device obtains the input parameter file name, determines the obtained file name, and sends an instruction for obtaining certificate stored in smart key to the smart key, receives certificate information returned from the smart key, and organizes the certificate information into the third data structure and returns the third data structure to the operating system in the case that the file name is the second file name.

Preferably, in Embodiment 1, the device obtaining the input parameter file name, sending the instruction for obtaining file information to the smart key according to the file name, and receiving the file information returned from the smart key, and organizing the file information into the third structure data and returning the third structure data to the operating system specifically includes that

the device obtains the input parameter file name, determines the obtained file name, and organizes the obtained certificate content into the data structure and returns the data structure to the operating system if the file name is the third file name.

Preferably, in Embodiment 1, the method further includes that the device returns function address list to the operating system when the first function of the device is invoked by the operating system.

Preferably, in Embodiment 1, the device returning the function address list to the operating system specifically is that the device initializes the first data structure, obtains the second function address, the third function address, the fourth function address, the fifth function address, the sixth function address, the seventh function address, and the eighth function address, constructs the second data structure which is defined by itself and stores the second data structure into the first data structure, and returns the first data structure to the operating system.

### Embodiment 2

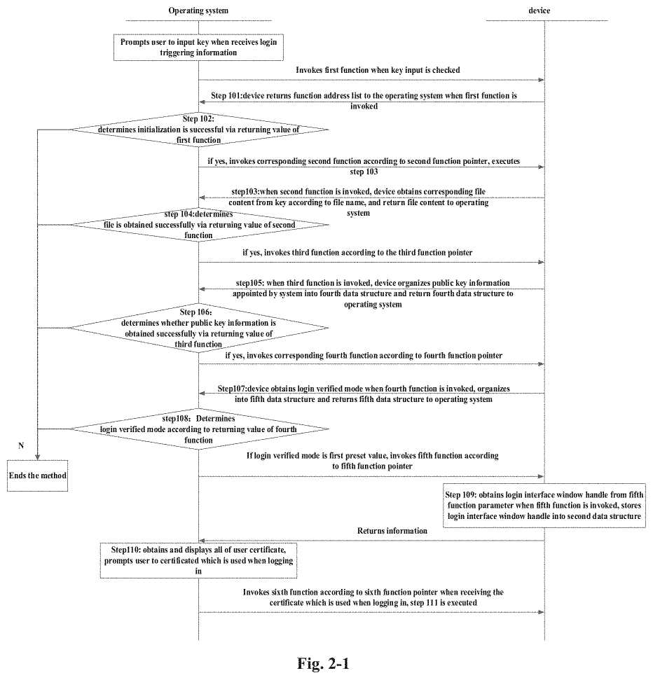

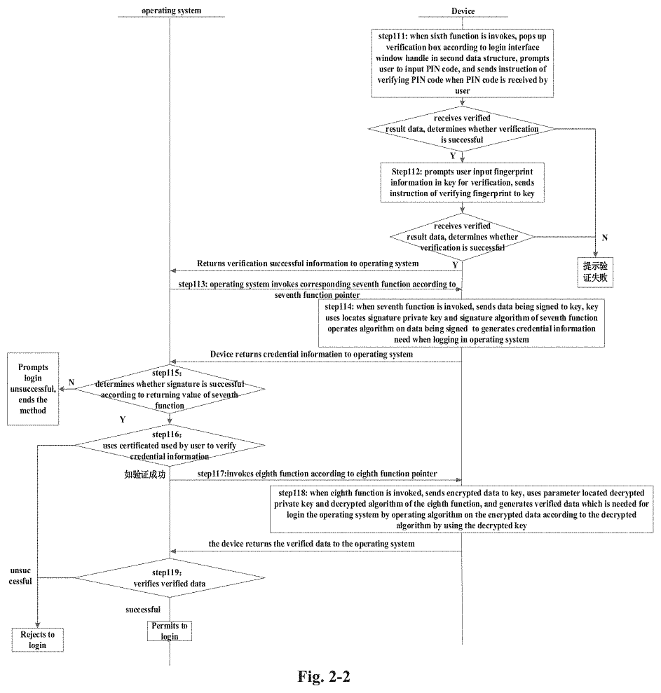

According to Embodiment 2, it provides a method for logging in a system by a smart key, which applies to the system which includes a device, an operating system and a smart key, as shown in FIG. 2-1 and FIG. 2-2, including:

in the case that receiving login triggering information, the operating system prompts a user to input the smart key; and invokes a first function when the operating system detects the smart key is input;

step 101, the device returns the function address list to the operating system when the first function is invoked;

specifically, in Embodiment 2, the first function is CardAcquireContext, in which, the input parameter includes a first data structure; the device returning the function address list to the operating system includes that initializing the first data structure, obtaining a second function address, a third function address, a fourth function address, a fifth function address, a sixth function address, a seventh function address, and an eighth function address, constructing a second data structure which is defined by itself, and storing the second data structure into the first data structure; the operating system invokes a corresponding function according to the second function address, the third function address, the fourth function address, the fifth function address, the sixth function address, the seventh function address and the eighth function address; preferably, the second function address, the third function address, the fourth address function, the fifth address function, the sixth function address, the seventh function address and the eighth function address is the second function pointer, the third function pointer, the fourth function pointer, the fifth function pointer, the sixth function pointer, the seventh function pointer and the eighth function pointer respectively.

step 102, the operating system determines whether the initialization is successful via a returning value of the first function, if yes, the operating system invokes the corresponding second function according to the second function pointer, and executes step 103; otherwise, ends the method.

In Embodiment 2, step 102 specifically is that the operating system determines the returning value of the first function, the initialization is successful if the returning value is the function address list; otherwise, the initialization fails.

step 103, the device obtains corresponding file content from the smart key according to the file name, organizes the file content into the third structure data and returns the third structure data to the operating system in the case that the second function is invoked.

Specifically, in Embodiment 2, the second function is CardReadFile, the input parameter includes the file name; in which, the first name is CardD, the second name is Cmapfile, the third name is cardcf, kxc00, and kxc01.

Preferably, the device obtaining corresponding file content according to the file name and returning the file content to the operating system specifically is that the device obtains the input parameter file name, determines the file name, the device executes step A1 if determining the file name is the first name; the device executes step A2 if determining the file is the second name; the device executes step A3 if determining the file name is the third name.

step A1, the device sends the instruction for obtaining smart key serial number to the smart key, and organizes received serial number into data structure and returns the data structure to the operating system;

step A2, the device sends instruction for obtaining certificate stored in the smart key to the smart key, determines whether certificate information returned from the smart key is received, if yes, organizes the obtained certificate information into the data structure and returns the data structure to the operating system; otherwise, ends the method.

Specifically, in Embodiment 2, the certificate information specifically includes a number of certificates, a key type, a length, and a function, etc.;

in which, the data structure CMapFile organized from the certificate information is:

```
typedef struct _CONTAINER_MAP_RECORD
{
  WCHAR wszGuid [MAX_CONTAINER_NAME_LEN + 1];
  BYTE bFlags;
  BYTE bReserved;
  WORD wSig smart key SizeBits;
  WORD w smart key Exchange smart key SizeBits;
} CONTAINER_MAP_RECORD, *PCONTAINER_MAP_RECORD;
```

step A3, the device organizes the obtained certificate content into the data structure and returns the data structure to the operating system.

step 104, the operating system determines whether the file is obtained successfully according to the returning value of the second function, if yes, the operating system invokes the corresponding third function according to the third function pointer, and executes step 105; otherwise, ends the method.

step 105, in the case that the third function is invoked, the device sends an instruction for obtaining public key information of appointed index container to the smart key according to the input parameter, receives the public key information returned from the smart key, and organizes the public key information into the fourth data structure and returns the fourth data structure to the operating system.

Specifically, in Embodiment 2, the third function is CardGetContainerdInfo;

the system input parameter is appointed index container identification;

for instance, the fourth data structure ContainerInfo is

```
                                          t
ypedef struct _CONTAINER_INFO
{
  DWORD dwVersion;
  DWORD dwReserved;
  DWORD cbSigPublic smart key;
  PBYTE pbSigPublic smart key;
  DWORD cb smart key ExPublic smart key;
  PBYTE pb smart key ExPublic smart key;
} CONTAINER_INFO, *PCONTAINER_INFO;
```

step 106, the operating system determines whether the public key information is obtained successfully via the returning value of the third function, if yes, the operating system invokes the corresponding fourth function according to the fourth function pointer, and executes step 107; otherwise, ends the method.

step 107, in the case that the fourth function is invoked, the device sends an instruction for obtaining login verified mode to the smart key, receives verified mode information returned from the smart key, and organizes the verified mode information into the fifth data structure and returns the fifth data structure to the operating system.

Specifically, in Embodiment 2, the fourth function is CardGetProperty, the input parameter includes the fifth data structure, and organizing the fifth data structure and returning the fifth data structure to the operating system specifically is that the device obtains verified policy identification from the received verified mode information returned from the smart key, and determines whether the verified mode is verifying fingerprint according to the verified policy identification, if yes, sets the verified type as the first preset value; otherwise, sets the verified type as the second preset value, and organizes the fifth data structure according to the set verified type, and returns the fifth data structure to the operating system;

in which, the verified type is set as the first preset value means that the login verified mode is verifying fingerprint; the login verified mode is verifying PIN code if the verified type is set as the second preset value;

in which, the verified policy identification is TouchPolicy; the verified type is PinType; the first preset value is ExternalPinType; the second preset value AuthenticationPin;

| for instance, the fifth data structure PIN_INFO is: | |
|---|---|
| typedef struct _PIN_INFO | |
| { | |
| DWORD | dwVersion; |
| SECRET_TYPE | PinType; |
| SECRET_PURPOSE | PinPurpose; |
| PIN_SET | dwChangePermission; |
| PIN_SET | dwUnblockPermission; |
| PIN_CACHE_POLICY | PinCachePolicy; |
| DWORD | dwFlags; |

} PIN_INFO, *PPIN_INFO;

Step 108, the operating system determines the type of login verification via the returning value of the fourth function, the operating system invokes the fifth function according to the fifth function pointer and executes step 109 if the type of login verification is the first preset value; otherwise, ends the method.

In Embodiment 2, the method further includes the operating system organizes the login interface window handle according to the verification type in the fifth data structure;

the operating system makes the login interface window handle obtained by organizing as a parameter and input the parameter in the case that the fifth function is invoked.

Step 109, in the case that the fifth function is invoked, the device obtains the login interface window handle from the fifth function parameter, and stores the login interface window handle into the second data structure, and returns an invoke response value to the operating system.

Specifically, in Embodiment 2, the fifth function is CardSetProperty, the input parameter is the first data structure and the login interface window handle, the said storing the login interface window handle into the second data structure specifically is that the device stores the login interface window handle into the second data structure which is in the first data structure.

step 110, the operating system obtains and displays all of the user certificates, prompts the user to choose a certificate which is used for login; the operating system invokes a corresponding sixth function according to the sixth function pointer, and executes step 111 when receiving the certificate which is used by the user for login.

step 111, in the case that the sixth function is invoked, the device pops up the verification box according to the login interface window handle in the second data structure to prompt the user to input PIN code, and sends the instruction for verifying PIN code to the smart key when receiving the PIN code input by the user; the device receives verified result data, and determines whether the verification is successful, if yes, executes step 112; otherwise, prompts the verification is unsuccessful.

Specifically, in Embodiment 2, the sixth function is CardAuthenticateEx;

Preferably, the device prompting the PIN code is verified unsuccessfully specifically includes that the device determines whether the number of left times for inputting PIN code is 0, if yes, prompts the smart key is locked, ends the method; otherwise, waits for receiving PIN code input by the user;

step 112, the device prompts the user to input fingerprint information in the smart key for verification, and sends the instruction for verifying fingerprint to the smart key; the device receives the verified result data, determines whether the verification is successful, if yes, returns the verification successful information to the operating system, and executes step 113; otherwise, prompts the verification is unsuccessful.

Preferably, the device prompting the fingerprint verified unsuccessfully specifically includes the device determines whether the number of left times for verifying fingerprint is 0, if yes, prompts the smart key is locked, ends the method; otherwise, waits for receiving fingerprint information input by the user.

step 113, the operating system invokes the seventh function according to the seventh function pointer, and executes step 114.

Specifically, in Embodiment 2, the seventh function is CardSignData; the system makes a container index, a signature algorithm identification and data being signed as parameters to invoke the seventh function.

step 114, in the case that the seventh function is invoked, the device sends the data being signed to the smart key, the smart key uses a parameter located signature private key and a signature algorithm of the seventh function, and generates credential information which is needed by the login operating system by operating on the data being signed according to the signature algorithm by using the signature private key, and the device returns the credential information to the operating system.

Specifically, in Embodiment 2, in which, the smart key using the parameter to locate signature private key and signature algorithm of the seventh function includes that the smart key obtains the signature private key and the signature algorithm from the corresponding container according to the container index and the signature algorithm identification in the parameters of the seventh function; and returns signing unsuccessful information to the operating system if the smart key signs unsuccessfully, and the seventh function returns error information.

For instance, in Embodiment 2, the data being signed includes a user name, a domain name, and a random number, etc.;

for instance, the credential information is:

```
    typedef struct _CARD_SIGNING_INFO
  {
    DWORD dwVersion;
    BYTE bContainerIndex;
    // See dw smart key Spec constants
    DWORD dw smart key Spec;
    // If CARD_BUFFER_SIZE_ONLY flag is present then the card
    // module should return only the size of the resulting
    // smart key in cbSignedData
    DWORD dwSigningFlags;
    // If the aiHashAlg is non zero, then it specifies the algorithm
    // to use when padding the data using PKCS
    ALG_ID aiHashAlg;
    // This is the buffer and length that the caller expects to be signed.
    // Signed version is allocated a buffer and put in cb/pbSignedData.
That should
    // be freed using PFN_CSP_FREE callback.
    PBYTE pbData;
    DWORD cbData;
    PBYTE pbSignedData;
    DWORD cbSignedData;
    // The following parameters are new in version 2 of the
    // CARD_SIGNING_INFO structure.
    // If CARD_PADDING_INFO_PRESENT is set in dwSigningFlags
    then
    // pPaddingInfo will point to the BCRYPT_PADDING_INFO
    structure
    // defined by dwPaddingType. Currently supported values are
    // CARD_PADDING_PKCS1, CARD_PADDING_PSS and
CARD_PADDING_NONE
    LPVOID pPaddingInfo;
    DWORD dwPaddingType;
  } CARD_SIGNING_INFO, *PCARD_SIGNING_INFO;
```

Step 115, the operating system determines whether the calculation signature is successful via the returning value of the seventh function, if yes, executes step 116; otherwise, prompts login failure, ends the method.

Specifically, in Embodiment 2, the calculation signature is successful if the seventh function returns the credential information; otherwise, calculation signature fails;

Step 116, the operating system verifies the credential information by using the certificate chosen by the user, executes step 117 if the credential information is verified successfully; otherwise, rejects login.

Specifically, in Embodiment 2, verifying the signature result by using the certificate chosen by the user specifically is that the operating system decrypts the signature result by using the signature public key in the certification chosen by the user, and operates hash algorithm on the data being signed, determines whether the hash algorithm result is the same as the decrypted result, if yes, the verification is successful; otherwise, the verification is unsuccessful.

Step 117, the operating system invokes the corresponding eighth function according to the eighth function pointer, and executes step 118.

Step 118, in the case that the eighth function is invokes, the device sends the encrypted data to the smart key, the smart key uses parameter located decrypted private key and decrypted algorithm of the eighth function, and generates verified data which is needed for login the operating system by operating algorithm on the encrypted data according to the decrypted algorithm by using the decrypted key, and the device returns the verified data to the operating system.

Specifically, in Embodiment 2, the eighth function is CardRSADecrypt; the system makes the container index, the encrypted algorithm identification and the encrypted data as parameters to invokes the eighth function.

```
  For instance, the verified data is typedef struct
  _CARD_RSA_DECRYPT_INFO
  {
    DWORD dwVersion;
    BYTE bContainerIndex;
    // For RSA operations, this should be AT_SIGNATURE or
AT_smart key EXCHANGE.
    DWORD dw smart key Spec;
    // This is the buffer and length that the caller expects to be decrypted.
    // For RSA operations, cbData is redundant since the length of the
    buffer
    // should always be equal to the length of the smart key modulus.
    PBYTE pbData;
    DWORD cbData;
    // The following parameters are new in version 2 of the
    // CARD_RSA_DECRYPT_INFO structure.
    // Currently supported values for dwPaddingType are
    // CARD_PADDING_PKCS1, CARD_PADDING_OAEP, and
CARD_PADDING_NONE.
    // If dwPaddingType is set to CARD_PADDING_OAEP, then
    pPaddingInfo
    // will point to a BCRYPT_OAEP_PADDING_INFO structure.
    LPVOID pPaddingInfo;
    DWORD dwPaddingType;
  } CARD_RSA_DECRYPT_INFO,
  *PCARD_RSA_DECRYPT_INFO;
```

Step 119, the operating system verifies the verified data, if the verified data is verified successfully, login is permitted; otherwise, reject to login.

Specifically, in Embodiment 2, the operating system verifying the verified data specifically is the operating system determines whether the verified data is the same as the data which is not decrypted, if yes, the verified data is verified successfully; otherwise, the verified data is verified unsuccessfully.

In Embodiment 2, the smart key claims it is a USB device when it inserts in the operating system;

Furthermore, the smart key can be replaced with a smart card, in which, the smart card can also realize the program provided in Embodiment 2 as the smart key when the smart card is inserted in the operating system via a card reader.

### Embodiment 3

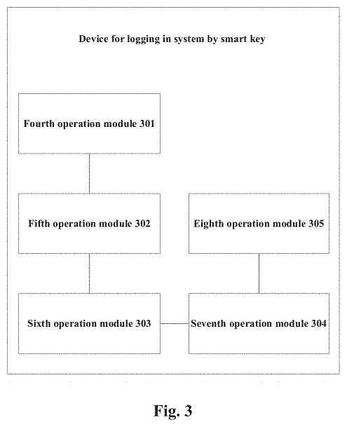

According to Embodiment 3, it provides a device for a smart key logging in a system, as shown in FIG. 3, the device includes that a fourth operation module 301, a fifth operation module 302, a sixth operation module 303, a seventh operation module 304, and an eighth operation module 305, in which

the fourth operation module 301 is configured to send an instruction for obtaining login verification mode to the smart key, and to receive verification mode information returned from the smart key, and organize the verification mode information into a fifth data structure and return the fifth data structure to the operating system;

the fifth operation module 302 is configured to obtain a login interface window handle in the fifth function parameter, and to store the login interface window handle into the second data structure, and return an invoking response value to the operating system;

a sixth operation module 303 is configured to pop up a verification box according to the login interface window handle in the second data structure stored by the fifth operation module, and to prompt the user to input PIN code, receive PIN code input by the user, and send an instruction for verifying PIN code to the smart key;

the sixth operation module 303 is further configured to receive PIN code verified result data returned from the smart key, determine whether the PIN code is verified successfully, if yes, prompt the user to input biological feature information in the smart key for verification, and send an instruction for verifying biological feature; otherwise, prompt the PIN code verified unsuccessfully;

the sixth operation module 303 is further configured to receive biological feature verified result data returned from the smart key, and determine whether the biological feature is verified successfully, if yes, return verification successful information to the operating system; otherwise, prompt biological feature verified unsuccessfully;

the seventh operation module 304 is configured to send the data being signed to the smart key, and receive signed data returned from the smart key, and organize signed data into credential information and return the credential information to the operating system; and

an eighth operation module 305 is configured to send the encrypted data to the smart key, and receive decrypted data returned from the smart key, and organize the decrypted data into verification data and return the verification data to the operating system.

Preferably, in Embodiment 3, the fourth operation module 301 is specifically configured to obtain the verification policy identification from the received verification mode information returned from the smart key, and determine whether the biological feature is verified according to the verification policy identification, if yes, set the verification type as the first preset value; otherwise, set the verification type as the second preset value, and organize the fifth data structure according to the set verification type, and return the fifth data structure to the operating system, and then the operating system organizes the login interface window handle according the verification type in the fifth data structure.

Preferably, in Embodiment 3, the device further includes a third operation module;

the third operation module is configured to send an instruction for obtaining public key information of appointed index container according to the parameter input by the operating system, and receive the public key information returned from the smart key, and organize the public key information into the fourth data structure and return the fourth data structure to the operating system.

Preferably, in Embodiment 3, the device further includes a second operation module;

the second operation module is configured to obtain parameter file name introduced by the operating system, send an instruction for obtaining file information to the smart key according to the file name, and receive the file information returned from the smart key, and organize the file information into the third structure data and return the third structure data to the operating system.

Preferably, in Embodiment 3, the second operation module is specifically configured to obtain the introduced parameter file name, determine the obtained file name, in the case that the file name is a first file name, send an instruction for obtaining smart key serial number to the smart key according to the first file name, and receive first file information returned from the smart key, and obtain the serial number from the first file information, and organize the third data structure according to the serial number and return the third data structure to the operating system.

Preferably, in Embodiment 3, the second operation module is specifically configured to obtain the introduced parameter file name, determine the obtained file name, in the case that the file name is the second file name, send an instruction for obtaining certificate stored in the smart key to the smart key according to the second file name, and receive certificate information returned from the smart key, and organize the obtained certificated information into the third data structure and return the third data structure to the operating system.

Preferably, in Embodiment 3, the second operation module is specifically configured to obtain the introduced parameter file name, and determine the file name, in the case that the file name is a third file name, organize the obtained certificate content into data structure and return the data structure to the operating system.

Preferably, in Embodiment 3, the device further includes a first operation module;

the first operation module is configured to return function address list to the operating system.

Preferably, in Embodiment 3, the first operation module is specifically configured to initial the first data structure, obtain a second function address, a third function address, a fourth function address, a fifth function address, a sixth function address, a seventh function address, and an eighth function address, build the second data structure which is defined by itself and store the second data structure into the first data structure, and return the first data structure to the operating system.

According to the present invention, a user can login Windows system more safely by combining outside PIN code verification and fingerprint verification in Windows function.

The above is detail introduction of a method and a device for a smart key to login a system according to the present invention, and the above embodiments just help to understand the concept in the present invention; meanwhile, any changes developed by techniques in the field belongs to the scope of the present invention.

1. A method for logging into a system by a smart key, wherein the method applies to the system including a device, an operating system and a smart key, the method comprises:
in the case that a fourth function of the device is invoked by the operating system, sending, by the device, an instruction for obtaining a login verification mode to the smart key, receiving verification mode information returned from the smart key, and organizing, by the device, the verification mode information into a fifth data structure and returning the fifth data structure to the operating system;
in the case that a fifth function of the device is invoked, obtaining, by the device, a login interface window handle in a fifth function parameter, storing the login interface window handle into a second data structure, and returning an invoking response value to the operating system;
in the case that a sixth function of the device is invoked by the operating system, popping up, by the device, a verification box according to the login interface window handle in the second data structure, prompting a user to input a PIN code, and sending an instruction for verifying the PIN code to the smart key when the PIN code input by the user is received;
in the case that the device receives PIN code verified result data returned from the smart key, determining, by the device, whether the PIN code is verified successfully, if yes, prompting the user to input biological feature information into the smart key for verification, and sending an instruction for verifying the biological feature to the smart key; otherwise, prompting the PIN code is verified unsuccessfully;
in the case that the device receives the biological feature verified result data returned from the smart key, determining, by the device, whether the biological feature is verified successfully, if yes, returning verification successful information to the operating system; otherwise, prompting the biological feature is verified unsuccessfully;
in the case that a seventh function of the device is invoked by the operating system, sending, by the device, data signed to the smart key, receiving signed data returned from the smart key, and organizing the signed data into credential information, and returning the credential information to the operating system; and
in the case that an eighth function of the device is invoked by the operating system, sending, by the device, encrypted data to the smart key, receiving decrypted data returned from the smart key, and organizing the decrypted data into verified data, and returning the verified data to the operating system.

2. The method as claimed in claim 1, wherein organizing, by the device, the verification mode information into the fifth data structure and returning the fifth data structure to the operating system specifically comprises
obtaining, by the device, a verification policy identification from the received verification mode information returned from the smart key, and determining whether the verification policy identification is a biological feature verification according to the verification policy identification, if yes, setting a verification type as a first preset value; otherwise, setting a verification type as a second preset value, and organizing the fifth data structure according the set verification type, and returning the fifth data structure to the operating system, so as to the operating system can organize the login interface window handle according to the verification type in the fifth data structure.

3. The method as claimed in claim 1, wherein said method further comprises in the case that a third function of the device is invoked by the operating system, sending, by the device, an instruction for obtaining public key information of an appointed index container to the smart key according to an introduced parameter, receiving the public key information returned from the smart key, and organizing the public key information into a fourth data structure, and returning the fourth data structure to the operating system.

4. The method as claimed in claim 1, wherein the method further comprises in the case that a second function of the device is invoked by the operating system, obtaining, by the device, a file name of the introduced parameter, sending an instruction for obtaining file information to the smart key according to the file name, receiving the file information returned by the smart key, and organizing a third structure data according to the file information and returning the third structure data to the operating system.

5. The method as claimed in claim 4, wherein obtaining, by the device, the file name of the introduced parameter, sending the instruction for obtaining file information to the smart key according to the file name, receiving the file information returned from the smart key, and organizing the third structure data according to the file information and returning the third structure data to the operating system specifically comprises:
obtaining, by the device, the file name of the introduced parameter, determining the obtained file name, sending, by the device, an instruction for obtaining a smart key serial number to the smart key according to a first file name, receiving first file information returned from the smart key, obtaining a serial number in the first file information, and organizing the third data structure according to the serial number and returning the third data structure to the operating system in the case that the file name is the first file name.

6. The method as claimed in claim 4, wherein obtaining, by the device, the file name of introduced parameter, sending the instruction for obtaining the file information to the smart key according to the file name, receiving the file information returned from the smart key, and organizing the third structure data according to the file information and returning the third structure data to the operating system specifically comprises:
obtaining, by the device, an introduced parameter file name, determining the obtained file name, sending, by the device, an instruction for obtaining a certificate stored in the smart key to the smart key according to a second file name in the case that the file name is the second file name, receiving the certificate information returned from the smart key, and organizing the obtained certificate information into a third data structure and returning the third data structure to the operating system.

7. The method as claimed in claim 4, wherein obtaining, by the device, the introduced parameter file name, sending the instruction for obtaining file information to the smart key according to the file name, receiving the file information returned from the smart key, and organizing the file information into the third data structure and returning the third structure to the operating system specifically comprises:
obtaining, by the device, the introduced parameter file name, determining the obtained file name, and organizing, by the device, an obtained certificate content into a data structure and returning the data structure to the operating system in the case that the file name is a third file name.

8. The method as claimed in claim 1, wherein the method further comprises returning, by the device, a function address list to the operating system in the case that a first function of the device is invoked by the operating system.

9. The method as claimed in claim 8, wherein returning, by the device, the function address list to the operating system specifically comprises: initializing, by the device, a first data structure, obtaining a second function address, a third function address, a fourth function address, a fifth function address, a sixth function address, a seventh function address and an eighth function address, building a second data structure which is defined by itself and storing the second data structure in the first data structure, and returning the first data structure to the operating system.

10. A device for logging into a system by a smart key, wherein the device comprises a fourth operation module, a fifth operation module, a sixth operation module, a seventh operation module, and an eighth operation module, in which
the fourth operation module is configured to send an instruction for obtaining a login verified mode to the smart key, receive verification mode information returned from the smart key, and organize the verification mode information into a fifth data structure and return the fifth data structure to the operating system;
the fifth operation module is configured to obtain a login interface window handle from a fifth function parameter, store the login interface window handle into a second data structure, and return an invoking response value to the operating system;
the sixth operation module is configured to pop up a verification box according to the login interface window handle stored by the fifth operation module in the second data structure, prompt a user to input a PIN code, receive the PIN code input by the user, and send an instruction for verifying the PIN code to the smart key;
the sixth operation module is further configured to receive PIN code verified result data returned from the smart key, determine whether the PIN code is verified successfully, if yes, prompt the user to input biological feature information in the smart key for verification, and send an instruction for verifying a biological feature to the smart key; otherwise, prompt the PIN code is verified unsuccessfully;
the sixth operation module is further configured to receive biological feature verified result data returned from the smart key, determine whether the biological feature is verified successfully, if yes, return verification successful information to the operating system; otherwise, prompt the biological feature is verified unsuccessfully;
the seventh operation module is configured to send the data to be signed to the smart key, receive signed data returned from the smart key, organize the signed data into credential information and return the credential information to the operating system; and
the eighth operation module is configured to send encrypted data to the smart key, receive decrypted data returned from the smart key, and organize the decrypted data into verified data, and return the verified data to the operating system.

11. The device as claimed in claim 10, wherein, the fourth operation module is specifically configured to obtain a verification policy identification from the received verified mode information returned from the smart key, and determine whether the verification policy identification is a biological feature verification, if yes, set a verification type as a first preset value; otherwise, set a verification type as a second preset value, organize the fifth data structure according to the set verification type, and return the fifth data structure to the operating system to make the operating system to organize the login interface window handle according to the verification type in the fifth data structure.

12. The device as claimed in claim 10, wherein the device further includes a third operation module;
the third operation module is configured to send an instruction for obtaining public key information of an appointed index container to the smart key according to a parameter input by the operating system, and receive the public key information returned from the smart key, and organize the public key information into the fourth data structure, and return the fourth data structure to the operating system.

13. The device as claimed in claim 10, wherein the device further includes a second operation module;
the second operation module is configured to obtain a parameter file name introduced by the operating system, send an instruction for obtaining file information to the smart key according to the file name, receive file information returned from the smart key, and organize a third structure data according to the file information and return the third structure data to the operating system.

14. The device as claimed in claim 13, wherein the second operation module is specifically configured to obtain the introduced parameter file name, determine the obtained file name, send an instruction for obtaining a smart key serial number according to a first file name if the file name is the first file name, and receive a first file information returned from the smart key, obtain the serial number from the first file information, organize the third data structure according to the serial number and return the third data structure to the operating system.

15. The device as claimed in claim 13, wherein the second operation module is specifically configured to obtain the introduced parameter file name, determine the obtained file name, in the case that the file name is a second file name, send an instruction for obtaining a certificate stored in the smart key to the smart key according to the second file name, and receive certificate information returned from the smart key, organize the obtained certificate information into the third data structure and return the third data structure to the operating system.

16. The device as claimed in claim 13, wherein the second operation module is specifically configured to obtain the introduced parameter file name, determine the obtained file name, in the case that the file name is a third file name, organize the obtained certificated content into data structure and return the data structure to the operating system.

17. The device as claimed in claim 10, wherein the device further comprises a first operation module;
the first operation module is configured to return a function address list to the operating system.

18. The device as claimed in claim 17, wherein the first operation module is specifically configured to initialize a first data structure, obtain a second function address, a third function address, a fourth function address, a fifth function address, a sixth function address, a seventh function address, and an eighth function address, build the second data structure which is defined by itself and store the second data structure into the first data structure, and return the first data structure to the operation module.
